(19) United States
(12) Patent Application Publication
(10) Pub. No.: US 2015/0041741 A1
(43) Pub. Date: Feb. 12, 2015

(54) TRAILER POWER LIFT SYSTEM

(71) Applicant: William J. Hyslop, Indianapolis, IN (US)

(72) Inventor: William J. Hyslop, Indianapolis, IN (US)

(21) Appl. No.: 14/338,443

(22) Filed: Jul. 23, 2014

Related U.S. Application Data
(60) Provisional application No. 61/857,353, filed on Jul. 23, 2013.

(51) Int. Cl. B60S 9/04

(52) U.S. Cl. CPC B60S 9/04
USPC 254/422

(57) ABSTRACT

The modification of a trailer tongue jack includes welding a telescoping section of tubing to a swivel. The telescoping section provides the desired height adjustment for the design of many trailers. A clevis unit is welded to the bottom of an inner tubing member for cooperation with a foot plate. With the tubing adjusted to the correct lift height and angled to the front or rear of the trailer, the user places the foot plate firmly on the support surface. Moving the trailer toward the foot plate lifts it off the support surface. The deflated tire can now be replaced with the spare tire. To lower the trailer, the user pulls the locator pin and turns it to the locator pin groove located on the top of the tubing. The trailer can now be lowered to the support surface by moving it forward or backward. Now return the unit to the storage horizontal position and release the swivel locking pin.

### REFERENCE TO RELATED APPLICATIONS

This application claims the benefit of U.S. Provisional Application No. 61/857,353, filed Jul. 23, 2013, which is incorporated by reference herein, in its entirety.

### BACKGROUND

A trailer power lift system is disclosed that will lift a trailer off the support surface so a deflated tire can be changed. Many people have experienced this problem with a boat or utility trailer tire and find it necessary to unload their car trunk or other storage area to access a car jack. A car jack may not fit and lift a trailer safely. Changing a deflated trailer tire, when the trailer is on the shoulder of the highway, can be dangerous. Also, the content of the storage area will be exposed to traffic, wind and possibly bad weather. Therefore, it's important to change the deflated tire in the least amount of time.

Given these realities, an appropriate solution as disclosed herein is to mount a swivel on the rear inside or outside of the trailer frame. The swivel has a telescoping unit, such as for example, a square or round tubing unit welded to it that has a height adjustment. This structure is adjusted to lift the trailer high enough to allow a fully inflated tire to be installed.

### SUMMARY

A trailer power lift system for changing a trailer tire is disclosed and includes a modification to a trailer tongue jack. This modification includes welding a telescoping section of tubing to a swivel. The telescoping section provides the desired height adjustment for the design of many trailers. A clevis unit is welded to the bottom of the inner tubing and includes a foot plate. With the tubing adjusted to the correct lift height for the particular trailer and tire size and angled to the front or rear of the trailer, the foot plate is placed firmly on a support surface. Moving the trailer toward the foot plate lifts the trailer off the support surface. When the swivel unit approaches a vertical lock position a warning light turns on. Now attempting to move the trailer with the swivel locked could damage the unit. The deflated tire can now be replaced with the spare tire. To lower the trailer, the user pulls a locator pin and turns it to the locator pin groove located on the top of the tubing. The trailer can now be lowered to the support surface by moving it forward or backward. Next the user returns the unit to the storage horizontal position and releases the swivel locking pin. When the trailer is on a sod support surface (i.e. soil) a spade attachment, mounted on the clevis bolt, is reversed and extends through the foot plate and into the ground. This anchors the foot plate and prevents it from slipping during the trailer lift.

More details of the tire changing procedure according to an exemplary embodiment of the present invention follow.

With a lug wrench, which has been stored in an accessible location, loosen the wheel lug nuts. Now, pull the swivel locking pin and adjust the length, by removing the bolt and wing nut and adjusting the overall length so it is approximately three inches greater than the distance from the top of the trailer frame to the support surface. Now, replace the bolt and wing nut and extend the foot toward the front or rear of the trailer. Place the foot plate firmly onto the support surface, so the sharp studs extending from the bottom, engage the support surface and provide traction. Move the trailer in the direction of the foot plate, which will lift the trailer due to the vaulting action of the unit. This step should be done carefully. When the telescoping section approaches the vertical position, a warning light turns on, the locator pin snaps into a hole, which locks the swivel and turns off the light. Additional travel in either direction could damage the unit. The spare tire can now be installed and the lug nuts tightened finger tight. To lower the trailer to the support surface, pull the locator pin and turn the handle one quarter turn clockwise. The locator pin will be held in a locator groove on top of the tubing unit which in the exemplary embodiment preferably uses square or round tubing. The trailer can now be moved forward or rearward, slowly, which will lower the wheel to the support surface. Now tighten the lug nuts, adjust the square tubing to its storage length, replace the bolt and wing nut, move the tubing to the horizontal storage position and turn the lock pin handle one quarter turn counterclockwise to release the pin and lock the swivel.

When changing a deflated tire, on a sod support surface, it may be necessary to use the spade attachment stored on the side of the telescoping unit. Remove the wing nut and spade from its mounting bolt. Insert the spade through the slot in the foot plate and mount it on the stud with the wing nut. The overall length adjustment is described above. Extend the down leg to the front or rear of the trailer and insert the spade into the sod. Moving the trailer in the direction of the foot plate will force the spade into the ground and guide the foot plate to a flat position on the support surface, which will then raise the trailer to the tire changing height. The deflated tire is now replaced with the spare, the trailer is lowered to the support surface, the spade is pulled from the ground and the system is returned to the storage position as described above.

If the described lift system is not stored on the side of the trailer where the deflated tire is located, unlock the security padlock and move the unit to the mounting on the opposite side of the trailer and lock the swivel to the side guide. An after market system would have to be removed from one side of the trailer and installed on the opposite side or have a system mounted on both sides.

Some of the features of the disclosed trailer power lift system include the following:
1. A magnet operated self contained warning light system that warns the vehicle operator when the swivel down leg is approaching the vertical lock position. An attempt to over travel the vertical locking position will damage any trailer lift system having a spring biased locking pin or a travel limiting stop.
2. A swivel that allows the down leg to turn 360 degrees and having a spring biased locator pin with four locking positions. The locator pin can be pulled, rotated one quarter turn clockwise and stowed in a retaining groove on top of the tubing. This will allow the vehicle operator to rotate the down leg beyond the vertical lock position without damaging the unit.
3. An angle iron frame, preferably U-shaped, welded to the trailer side rails locates the swivel back plate. A padlock will connect them and allow a quick relocation of the lift unit from side to side. Welding angle iron side guides on the trailer tongue or forward on the trailer rail would allow the lift unit to be installed there. Then by raising the tongue with the jack and lowering the foot plate with spikes, to the support surface, will keep the trailer in that position. The padlock will also provide security.
4. The lift unit can be located on the inside or outside of the trailer side rails. When located on the inside of the rail, in a horizontal position, it is hidden from view and the trailer contour is maintained.
5. The trailer can be lifted by moving the trailer forward or backward.
6. The trailer can be lowered by moving the trailer forward or backward.
7. The spade mounts on the clevis bolt and is stored on the inside or outside of the telescoping unit. It is used when lifting a trailer from a sod support surface.
8. The spade extends through the foot plate slot and is pushed 6 inches into the sod while guiding the foot plate down onto the sod support surface. This is accomplished by the movement of the towing vehicle.
9. Stored in the ready to use adjustment, on the average 22 inches high trailer side rail, require 25 inches of side rail storage space. A fully inflated trailer tire will be raised 3 inches off the support surface when the overall length of the lift unit is 25 inches. The minimum adjustable overall length of the lift unit is 16 inches.

### BRIEF DESCRIPTION OF THE DRAWINGS

FIG. 1 is a perspective view of a boat, trailer and a trailer power lift system mounted on the side of the trailer frame according to an exemplary embodiment of the present invention.

FIG. 2 is an exploded view of the FIG. 1 lift system.

FIG. 3 is a perspective view of the FIG. 1 lift system in the beginning lift position.

FIG. 4 is a perspective view of the FIG. 1 lift system with a swivel in the vertical position and a foot plate on the support surface.

FIG. 5 is a perspective view of the FIG. 1 lift system in the lifted position and the swivel pin in the locked position. Also shown is an additional possible location for the lift system to anchor the trailer with foot plate spikes.

FIG. 6 is a perspective view of the FIG. 5 swivel locator pin pulled, turned and held in the retracted position. This feature allows the same person to then move the trailer forward or back and lower the trailer to the support surface.

FIG. 7 is a perspective view of the FIG. 1 lift system with a spade mounted on the clevis bolt and passing through the foot plate.

FIG. 8 is a perspective view of the FIG. 1 lift system from the front showing the trailer lifted and the swivel pin in the locked position.

FIG. 9 is a perspective view of the FIG. 8 configuration with the swivel pin retracted.

FIGS. 10-18 are perspective view drawings showing the structural details and specific construction of an exemplary embodiment of the FIG. 1 lift system.

### DESCRIPTION OF THE PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail; although it will be apparent to those skilled in the relevant art that some features that are not relevant to the present invention may not be shown for the sake of clarity.

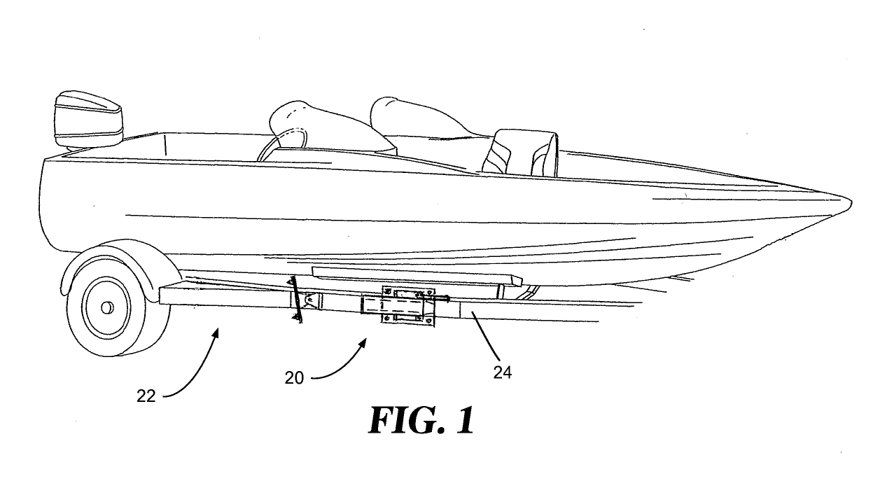

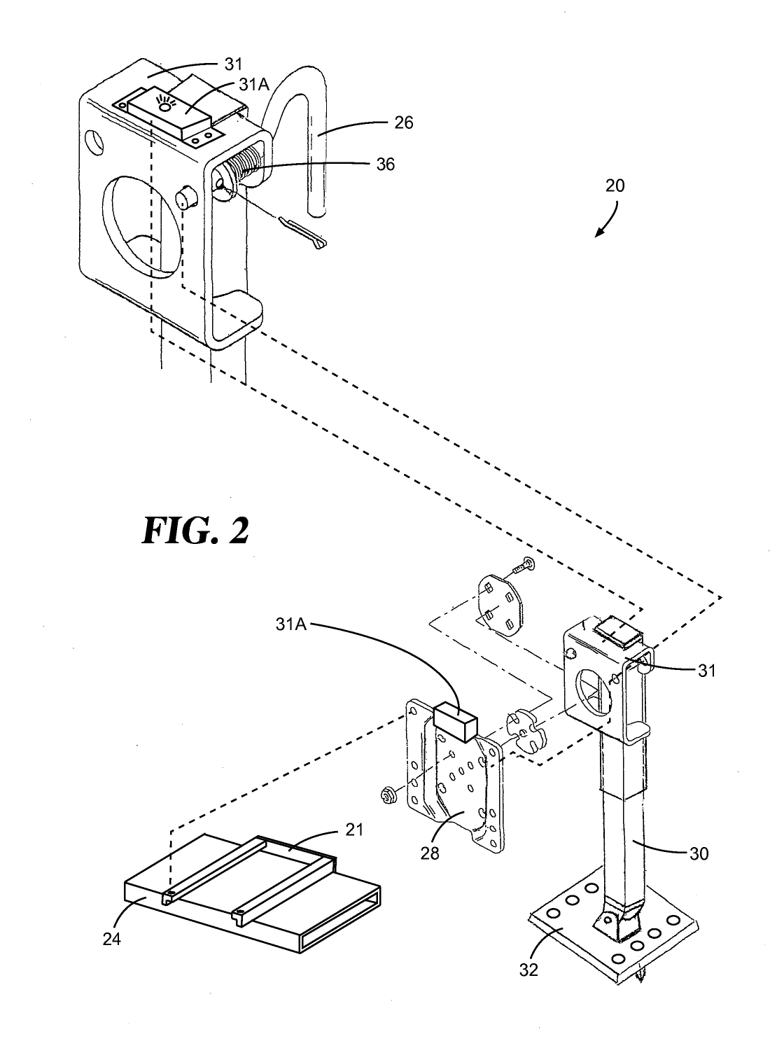

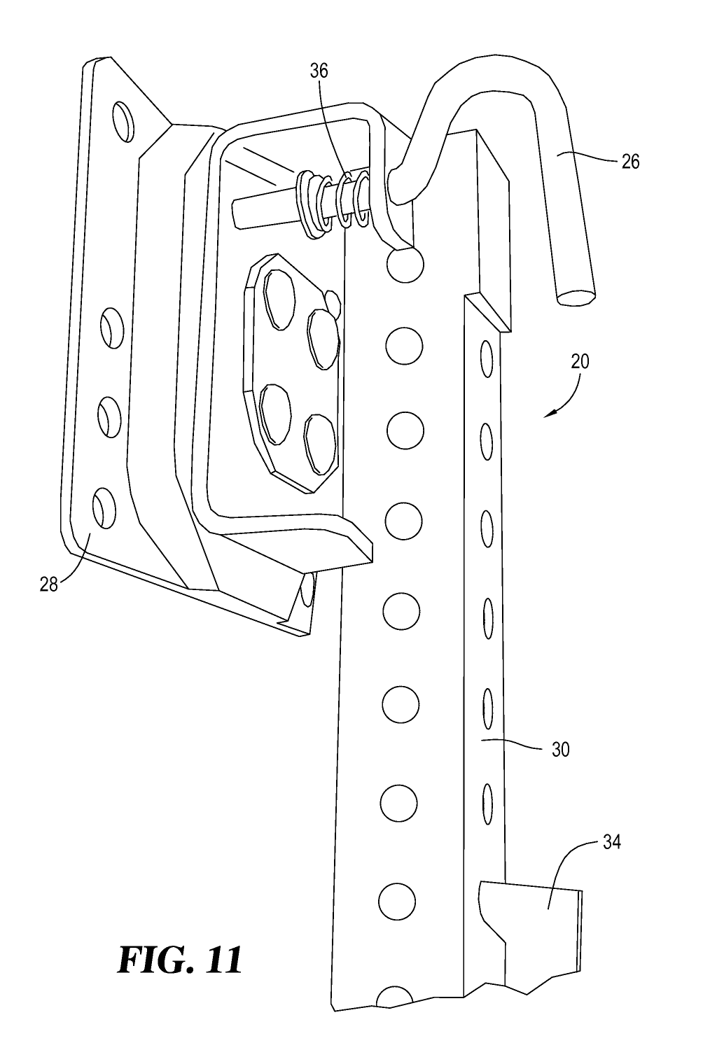

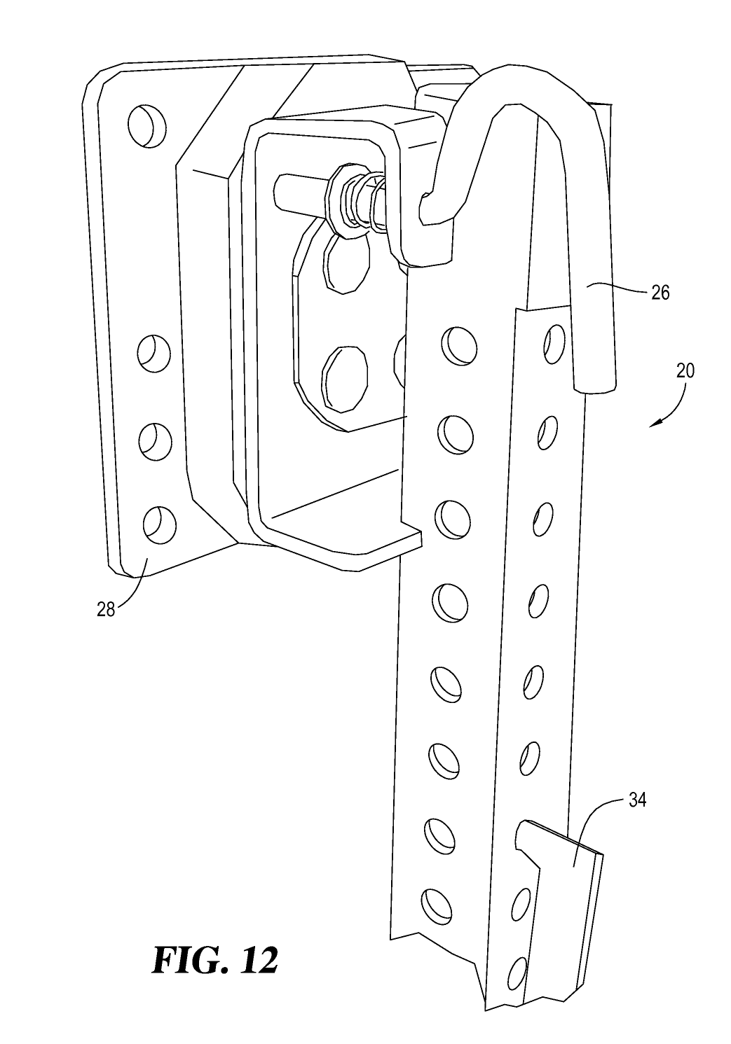

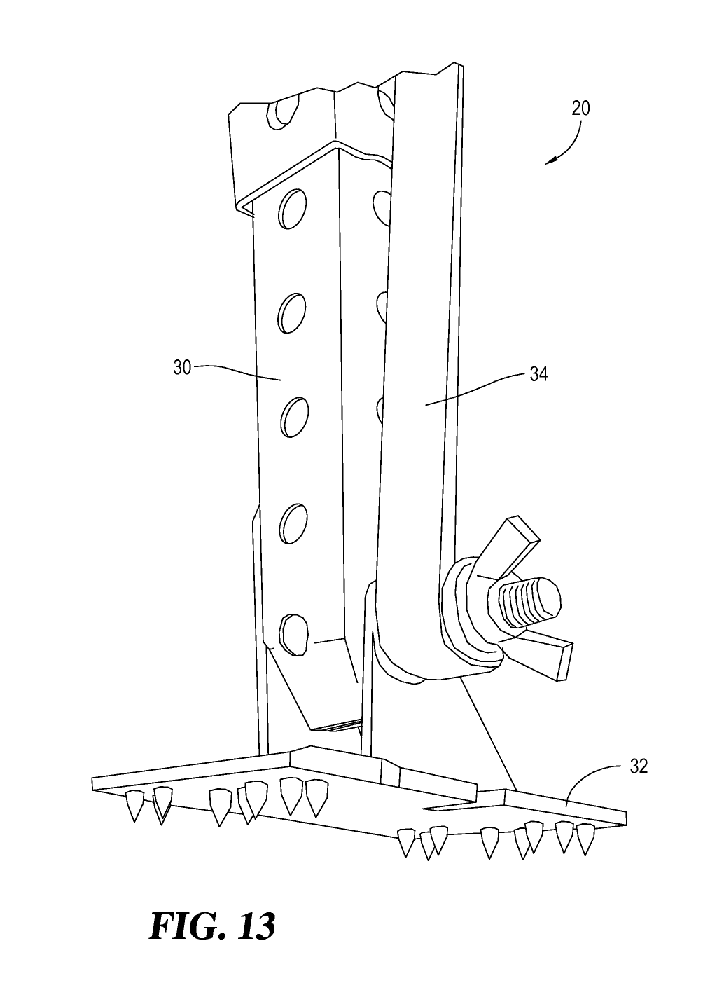

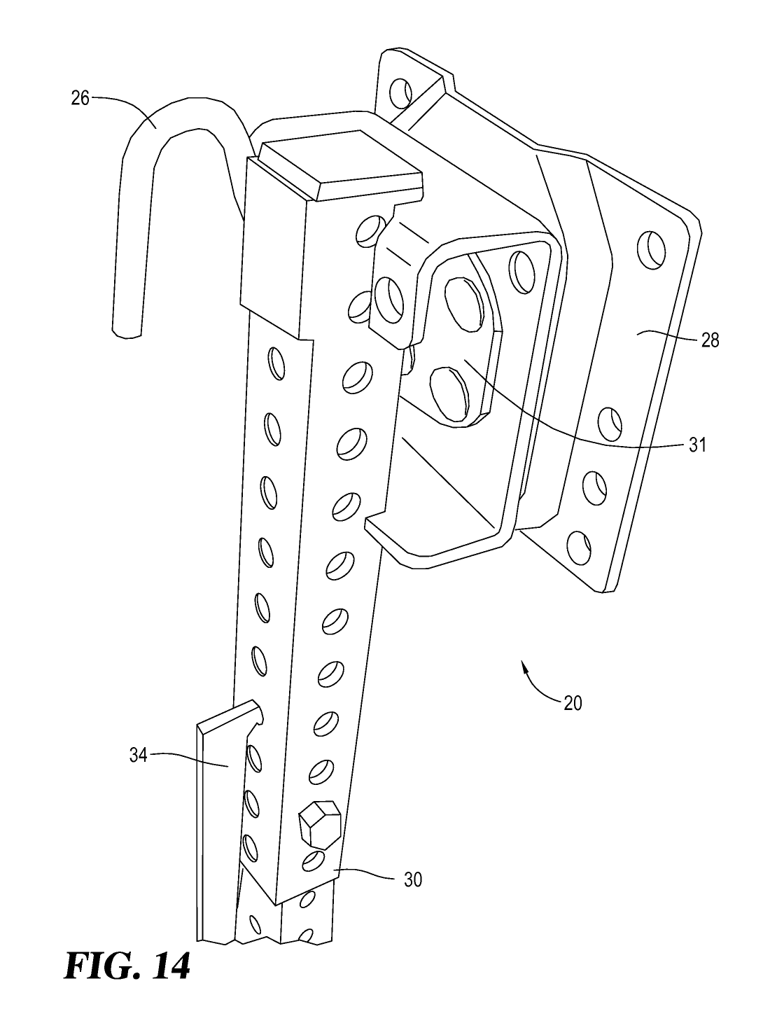

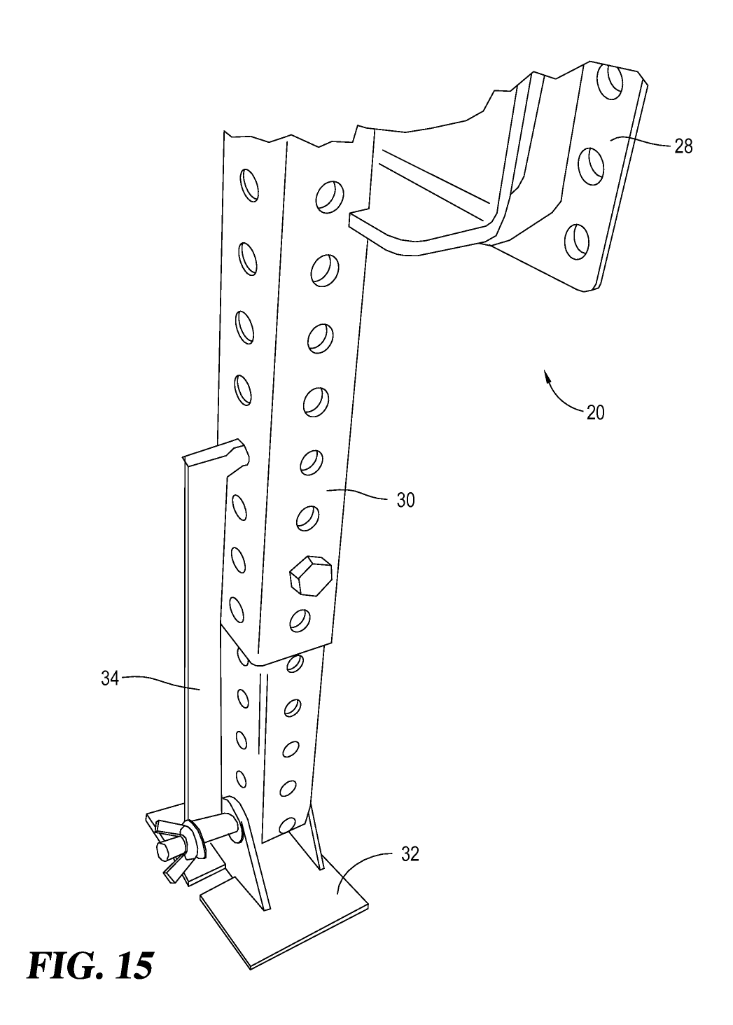

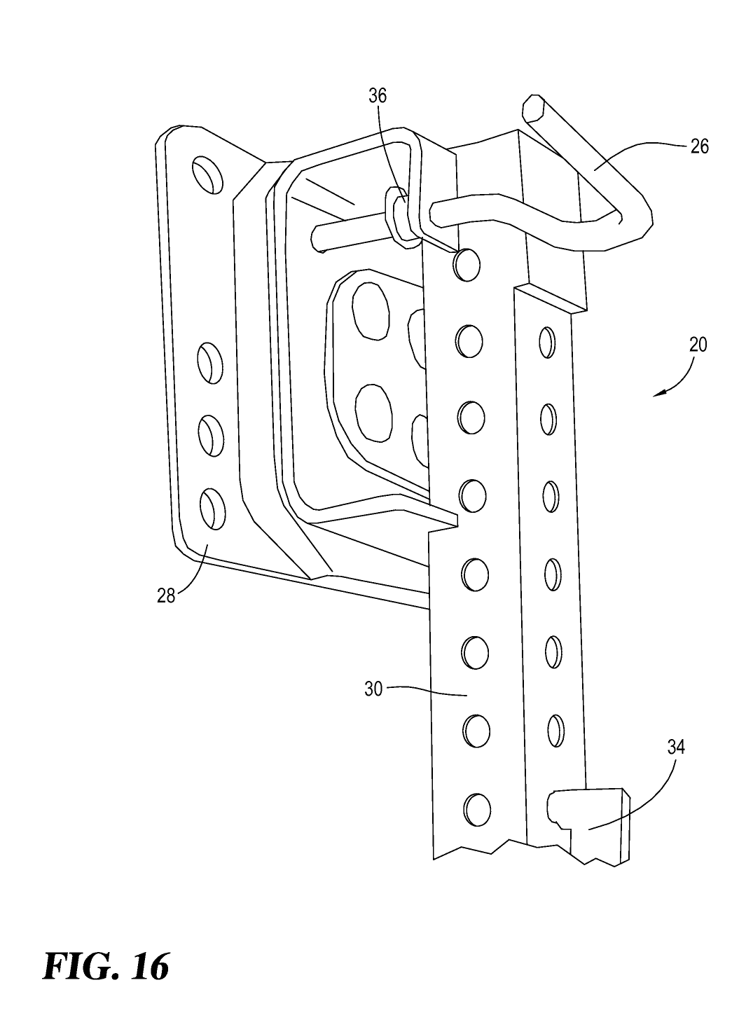

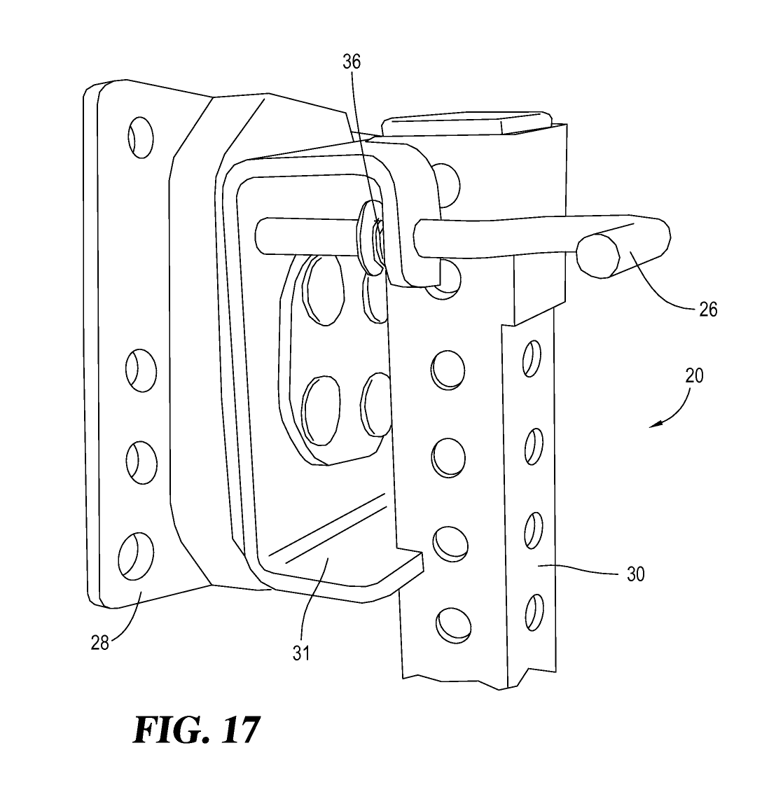

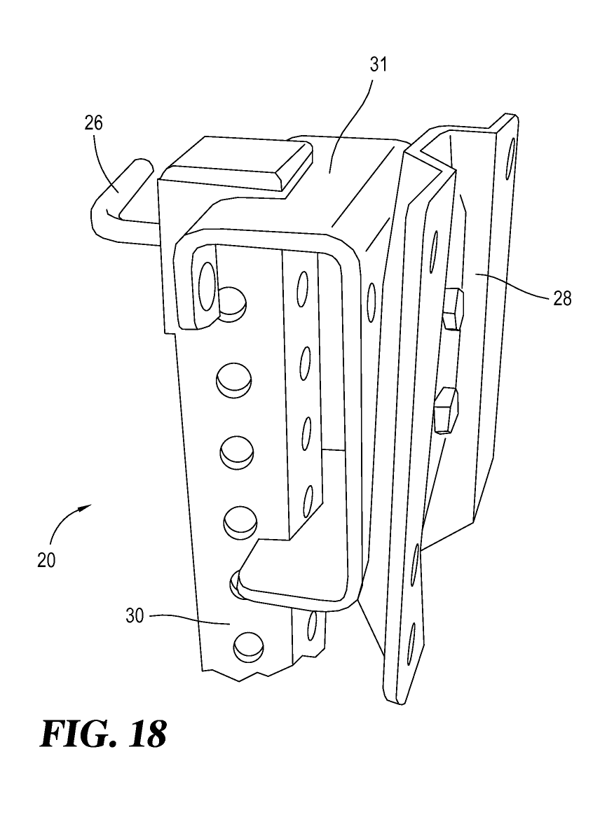

Before describing the specific structures of FIGS. 1-18, a general narrative is provided summarizing the tire changing procedure. More details of the tire changing procedure according to an exemplary embodiment of the present invention follow.

With a lug wrench, which has been stored in an accessible location, loosen the wheel lug nuts. Now, pull the swivel locking pin and adjust the length, by removing the bolt and adjusting the overall length so it is approximately three inches greater than the distance from the top of the trailer frame to the support surface. Now, replace the bolt and extend the foot toward the front or rear of the trailer. Place the foot plate firmly onto the support surface, so the sharp studs extending from the bottom, engage the support surface and provide traction. Move the trailer in the direction of the foot plate, which will lift the trailer due to the vaulting action of the unit. This step should be done carefully. When the telescoping section approaches the vertical position, a warning light turns on, the locator pin snaps into a hole, which locks the swivel and turns off the light. Additional travel in either direction could damage the unit. The spare tire can now be installed and the lug nuts tightened finger tight. To lower the trailer to the support surface, pull the locator pin and turn the handle one quarter turn clockwise. The locator pin will be held in a locator groove on top of the tubing unit which in the exemplary embodiment preferably uses square or round tubing. The trailer can now be moved forward or rearward, slowly, which will lower the wheel to the support surface. Now tighten the lug nuts, adjust the square tubing to its storage length, replace the bolt, move the tubing to the horizontal storage position and turn the lock pin handle one quarter turn counterclockwise to release the pin and lock the swivel.

When changing a deflated tire, on a sod support surface, it may be necessary to use the spade attachment stored on the side of the telescoping unit. Remove the wing nut and spade from its mounting bolt. Insert the spade through the slot in the foot plate and mount it on the stud with the wing nut. The overall length adjustment is described above. Extend the down leg to the front or rear of the trailer and insert the spade into the sod. Moving the trailer in the direction of the foot plate will force the spade into the ground and guide the foot plate to a flat position on the support surface, which will then raise the trailer to the tire changing height. The deflated tire is now replaced with the spare, the trailer is lowered to the support surface, the spade is pulled from the ground and the system is returned to the storage position as described above.

If the described lift system is not stored on the side of the trailer where the deflated tire is located, unlock the security padlock and move the unit to the mounting on the opposite side of the trailer and lock the swivel to the side guide. An after market system would have to be removed from one side of the trailer and installed on the opposite side or have a system mounted on both sides.

Some of the features of the disclosed trailer power lift system include the following:
1. A magnet operated self contained warning light system that warns the vehicle operator when the swivel down leg is approaching the vertical lock position. An attempt to over travel the vertical locking position will damage any trailer lift system having a spring biased locking pin or a travel limiting stop.
2. A swivel that allows the down leg to turn 360 degrees and having a spring biased locator pin with four locking positions. The locator pin can be pulled, rotated one quarter turn clockwise and stowed in a retaining groove on top of the tubing. This will allow the vehicle operator to rotate the down leg beyond the vertical lock position without damaging the unit.
3. An angle iron frame, preferably U-shaped, welded to the trailer side rails locates the swivel back plate. A padlock will connect them and allow a quick relocation of the lift unit from side to side. Welding angle iron side guides on the trailer tongue or forward on the trailer rail would allow the lift unit to be installed there. Then by raising the tongue with the jack and lowering the foot plate with spikes, to the support surface, will keep the trailer in that position. The padlock will also provide security.
4. The lift unit can be located on the inside or outside of the trailer side rails. When located on the inside of the rail, in a horizontal position, it is hidden from view and the trailer contour is maintained.
5. The trailer can be lifted by moving the trailer forward or backward.
6. The trailer can be lowered by moving the trailer forward or backward.
7. The spade mounts on the clevis bolt and is stored on the inside or outside of the telescoping unit. It is used when lifting a trailer from a sod support surface.
8. The spade extends through the foot plate slot and is pushed 6 inches into the sod while guiding the foot plate down onto the sod support surface. This is accomplished by the movement of the towing vehicle.
9. Stored in the ready to use adjustment, on the average 22 inches high trailer side rail, require 25 inches of side rail storage space. A fully inflated trailer tire will be raised 3 inches off the support surface when the overall length of the lift unit is 25 inches. The minimum adjustable overall length of the lift unit is 16 inches.

Referring to FIGS. 1-4, a trailer power lift system 20 is illustrated as mounted to a boat trailer 22. System 20 is mounted to frame 24 using a U-shaped angle iron member 21, with holes, that is welded to frame 24. The swivel mounting plate 28 slips into the U-shaped member 21 and is secured with a padlock. This allows system 20 to be unlocked and quickly moved to the location of the deflated tire. System 20 has a swivel construction so as to enable a portion of system 20 to pivot as a part of the deployment.

A mounting method and structure is shown which uses a U-shaped angle iron member that is welded to each side and tongue area of the trailer frame. The swivel mounting plate will slip into the angle iron frame and be secured with a padlock The disclosed lift system can be quickly moved to the opposite side. A self contained warning light system is mounted on top of the swivel. A light is turned on when the telescope section approaches the vertical lock position and turned off when the swivel is locked. There are two LED's, which makes one visible when the unit is mounted on either side of the trailer.

The first step in the deployment is to release the locking pin 26 from its receiving hole in plate 28. This allows the system arm 30 (telescoping) to begin to pivot toward the ground. System arm 30 includes an outer member with frame 31 securely assembled to it and an inner (telescoping) member. Plate 28 remains anchored to frame 24 and arm 30 extends from plate 28 to foot plate 32. System 20 could also be moved to a U-shaped member 21 mounted on the trailer tongue. Lowering foot plate 32 to the ground and raising the tongue jack would anchor the trailer in its present location with the foot plate spikes.

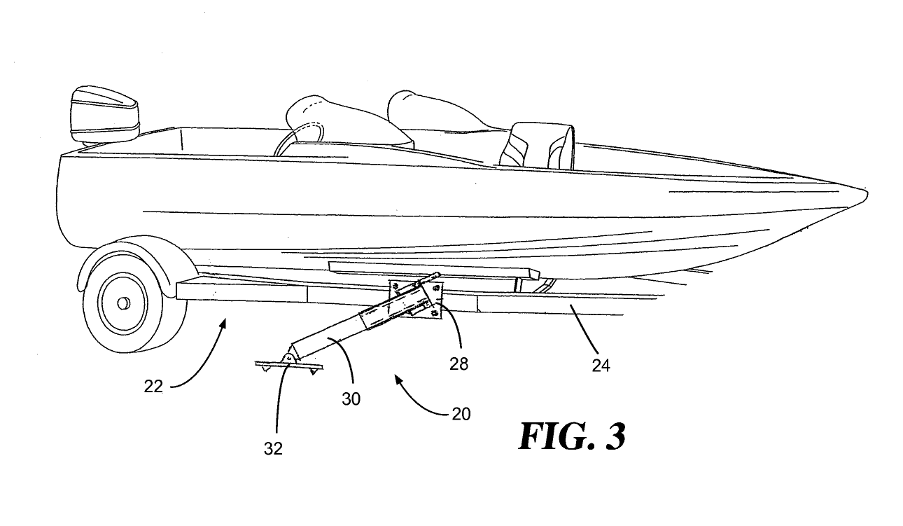

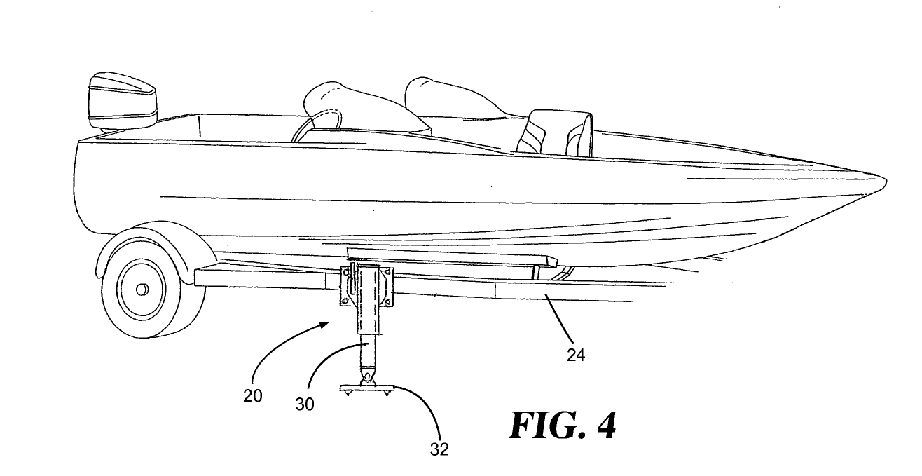

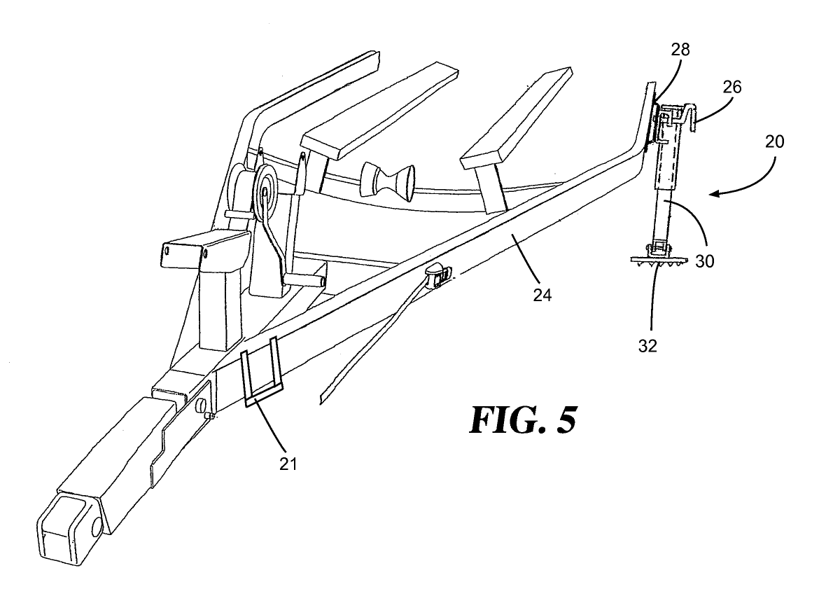

Working from the orientation in FIG. 3, it will be seen that as the towing vehicle is slowly and carefully driven in the reverse direction, the foot plate 32 is anchored to the ground (support surface) and the arm 30 pivots in a counterclockwise direction. This movement then lifts the trailer and raises the flat tire off of the ground a sufficient height to be able to remove the flat tire and put on a fully inflated spare tire. The pivoting occurs at the location of plate 28 and pivoting also occurs at the foot plate 32. As arm 30 approaches the vertical position, a warning light 31a is turned on to warn the vehicle driver that the swivel is approaching the lock position. In the vertical condition of arm 30, as illustrated, the locking pin 26 which is spring biased by spring 36, snaps into a receiving hole to lock the system 20 in this lifted, vertical condition and turns off the warning light. The final lifted position is illustrated in FIGS. 4 and 5.

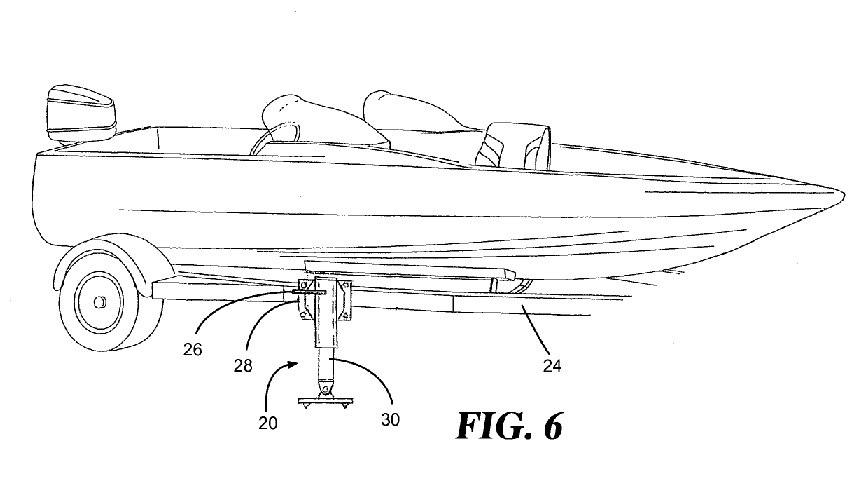

Referring now to FIG. 6, the flat tire has been changed and the system 20 is ready to be stowed. The process begins by pulling pin 26 and turning the handle ¼turn clockwise to the locator groove on top of the tubing. This keeps the swivel in the unlocked position and allows it to rotate. Now, moving the trailer (via the towing vehicle) either forward or reverse will begin the pivoting of the arm 30. The option of moving the trailer in either direction assumes that stowing space is available along the trailer frame either forward or aft of the connection location of the securing plate 28.

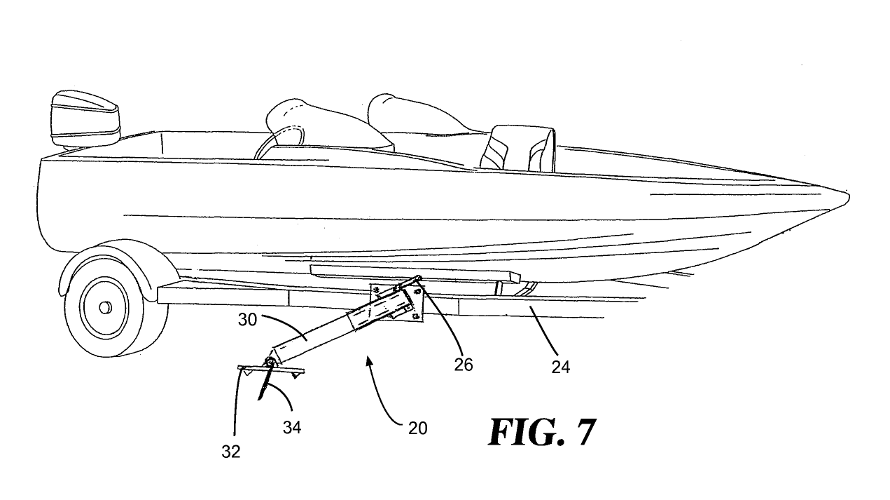

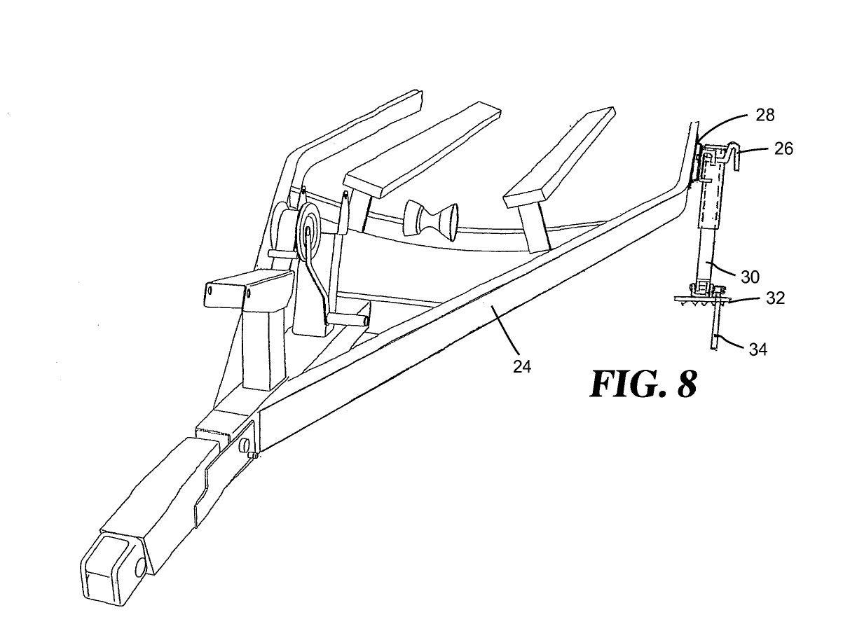

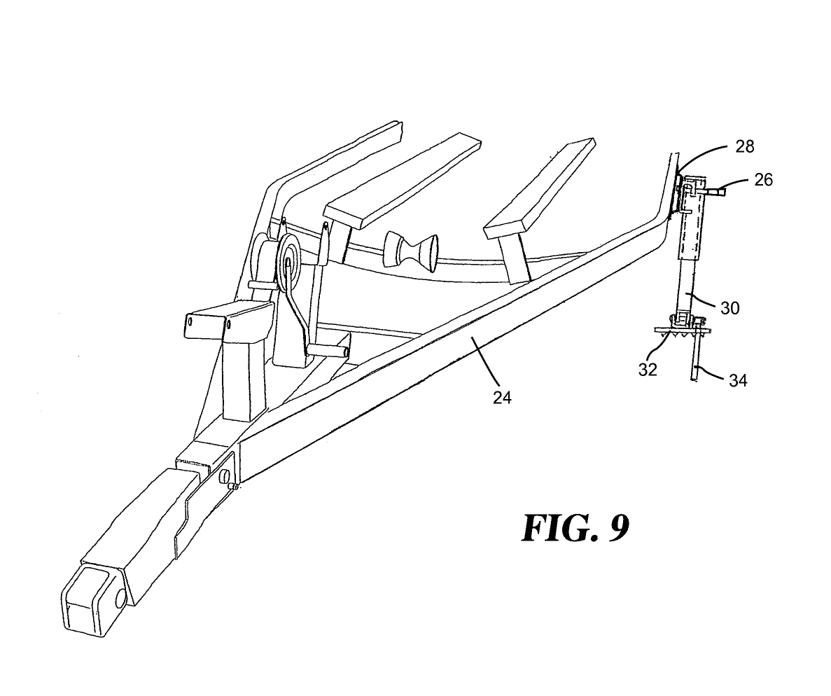

Referring now to FIGS. 7-9, another feature of the disclosed embodiment is illustrated. A “spade” anchor 34 is removably attached to the side of the telescoping arm 30. This anchor 34 can be removed and reassembled to insert into soft soil/sod. The spade guides the foot plate to the support surfaces and the trailer movement forces it into the soil. The spade prevents the foot plate from slipping on the sod support surface during the trailer lift. The three stages of deployment are illustrated, starting with the release and initial insertion of the anchor 34 through the slot in foot plate 32 and into the ground (see FIG. 7). In FIG. 8, the system 20 is fully deployed and locked. In FIG. 9, the system 20 is ready to be retracted and stowed (noting the change in position of the locking pin 26). Moving the trailer forward or back will lower the trailer to the support surface and pull the spade out of the soil.

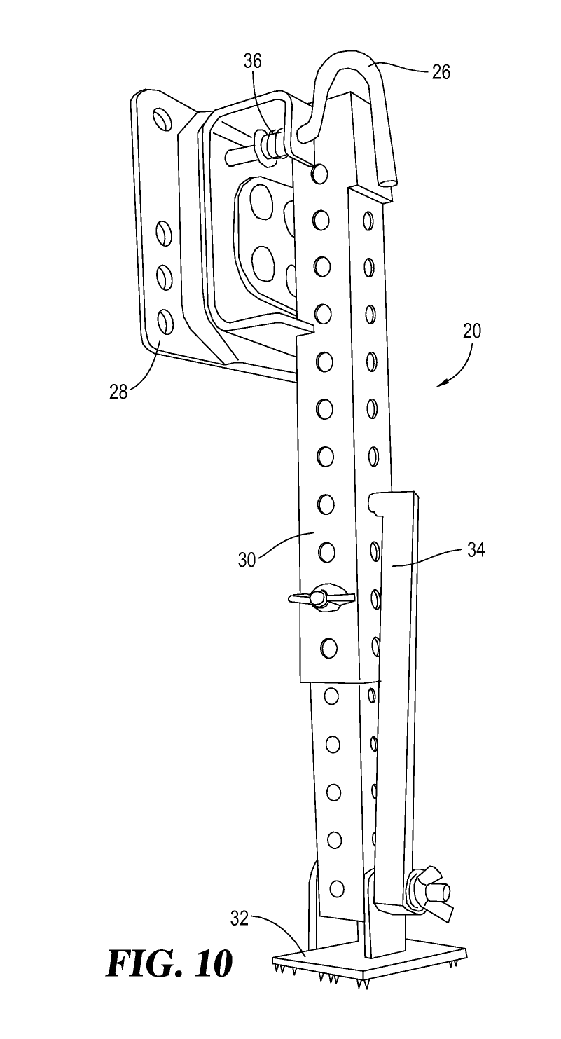

Other construction details of system 20 are disclosed by FIGS. 10-18. Additionally, the following features and procedures are disclosed as part of or relating to system 20.

The trailer power lift system 20 raises the trailer by the movement of the towing vehicle and the lift system's contact with the support surface.

Trailer rails that are 13 inches to 24 inches above the support surface can be raised to provide three inches of clearance to install a fully inflated tire. Adjusting the telescoping unit so 8 holes are visible above the clevis wing nut will raise the average trailer 3 inches off the support surface.

The foot plate is mounted on the bottom of the tubing by a clevis arrangement that will allow it to rotate approximately forty five degrees clockwise or counterclockwise from the perpendicular position at the bottom of the tubing.

The swivel unit has been modified. The locking pin has a pulled permanent unlocked position that will allow it to rotate 360 degrees. This feature is unique and allows one person to unlock the swivel, after the tire has been changed and then drive the towing vehicle to lower the trailer to the support surface.

The lift system 20 can raise or lower the trailer by driving the towing vehicle forward or backward.

A spade is stored on the side of the telescoping unit. It is mounted on the clevis stud and moves with the inner tubing. The sharp end of the spade is held in position by the end width extension that fits into the tubing holes. The spade can also be stored inside the lower telescoping unit.

When the trailer is on a sod support surface, the spade is inserted through the slot in the foot plate and mounted on the clevis stud. With the telescoping unit adjusted to the correct height and on an approximate forty five degree angle to the front or rear of the trailer, start the spade into the ground. When the trailer is moved in the direction of the foot plate, the spade will guide the foot plate to the support surface as the spade is forced into the soil and the trailer is lifted.

Included is a self contained warning light system. When the swivel approaches the vertical lock position, a magnetic switch turns on a warning light. When the swivel reaches the vertical position, the light is turned off and the pin locks the swivel.

The location of the lift system 20 can quickly be switched from side to side by mounting two pieces of angle iron on each side of the trailer frame. The swivel mounting plate is placed in the angle iron frame and a padlock runs through the holes in the swivel mounting plate and the U-shaped frame This arrangement requires just one system per trailer and the padlock provides security. The lift system 20 can also be mounted on the trailer tongue. Lowering the foot plate to the ground and raising the tongue jack anchors the trailer in its present location with the foot plate spikes.

While the embodiments have been illustrated and described in detail in the drawings and foregoing description, the same is to be considered as illustrative and not restrictive in character, it being understood that only particular embodiments have been shown and described and that all changes and modifications that come within the spirit of the disclosure are desired to be protected.

1. A lift system for a trailer is constructed and arranged for use in changing a tire of the trailer, said lift system comprising:
a support member constructed and arranged for being secured to a portion of said trailer;
a mounting plate assembled to said support member, said mounting plate being constructed and arranged to be able to swivel;
a locking pin received by said mounting plate; and
a lift arm assembled to said mounting plate, wherein said lift arm is deployable by swivel movement of said support member after release of said locking pin.

2. The lift system of claim 1 wherein said lift arm has a telescoping construction using an inner member and an outer member.

3. The lift system of claim 2 wherein said lift arm has a length which is adjustable and lockable.

4. The lift system of claim 3 which further includes a foot plate which is pivotally connected to said lift arm.

5. The lift system of claim 4 wherein said locking pin is spring biased.

6. The lift system of claim 5 wherein said outer member includes a frame which receives said locking pin.

7. The lift system of claim 6 which further includes a warning light.

8. The lift system of claim 7 wherein said warning light is assembled into said frame.

9. The lift system of claim 1 wherein said lift arm has a length which is adjustable and lockable.

10. The lift system of claim 1 which further includes a foot plate which is pivotally connected to said lift arm.

11. The lift system of claim 1 wherein said locking pin is spring biased.

12. The lift system of claim 1 wherein said outer member includes a frame which receives said locking pin.

13. The lift system of claim 1 which further includes a warning light.

14. The lift system of claim 13 wherein said warning light is assembled into said frame.

15. The lift system of claim 1 which further includes a spade structure for insertion into soil.

16. A lift system for a trailer is constructed and arranged for use in lifting the trailer, said lift system comprising:
a support member constructed and arranged for being secured to a portion of said trailer;
a lift arm which is constructed and arranged to be deployed for use in lifting said trailer; and
swivel means positioned between said support member and said lift arm for deploying said lift arm.

17. The lift system of claim 16 which further includes a locking pin which is received by said swivel means.

18. The lift system of claim 17 wherein said lift arm has a telescoping construction using an inner member and an outer member.

19. The lift system of claim 18 wherein said lift arm has a length which is adjustable and lockable.

20. The lift system of claim 19 wherein said locking pin is spring biased.
